(19) United States
(12) Patent Application Publication
(10) Pub. No.: US 2018/0218003 A1
(43) Pub. Date: Aug. 2, 2018

(54) EPHEMERAL BLOCKCHAIN DATA STRUCTURE

(71) Applicant: General Electric Company, Schenectady, NY (US)

(72) Inventors: Vineet Banga, San Ramon, CA (US); Atul Chandrakant Kshirsagar, San Ramon, CA (US)

(21) Appl. No.: 15/419,765

(22) Filed: Jan. 30, 2017

(51) Int. Cl. G06F 17/30

(52) U.S. Cl. CPC G06F 17/30117; G06F 17/30097

(57) ABSTRACT

Multiple blockchains have block data strictures with different event granularities. A first blockchain adds blocks according to a data structure with high event granularity. A second blockchain adds a block digest according to a data structure with low event granularity. The block digest is a digest of the blocks added to the first blockchain.

### TECHNICAL FIELD

This document generally relates to methods and systems for an ephemeral blockchain structure.

### BACKGROUND

Typically, blockchains store data permanently. Blockchain data can include multiple small events that actually are components of a single large event. Storage by the blockchain of all of the small events helps tracking and auditing as the single large event is completed. However, an undesirable result is large consumption of storage space and transaction cost per stored event based on the type of blockchain consensus.

### BRIEF DESCRIPTION OF THE DRAWINGS

The drawings illustrate example embodiments of the present disclosure and do not limit the scope of the present disclosure.

FIG. 1 is a simplified diagram of permanent and ephemeral blockchain networks.

FIG. 2 is a simplified diagram of an ephemeral blockchain growing with additional blocks.

FIG. 3 is a simplified diagram of a permanent blockchain growing with an additional block in the form of a digest block.

FIG. 4 is an example use case diagram showing the interaction among entities with a regularly deleted ephemeral blockchain.

FIG. 5 is an example use case diagram showing the interaction among entities with an occasionally deleted ephemeral blockchain.

FIG. 6 is a block diagram illustrating an example of a software architecture that may be installed on a machine, according to some example embodiments, to perform any of the methodologies described herein.

FIG. 7 is a diagrammatic representation of a machine in the form of a computer system within which a set of instructions may be executed for causing the machine to perform any one or more of the methodologies discussed herein, according to an example embodiment.

### DETAILED DESCRIPTION

Some data is intermediate in a larger overall event. Once the larger overall event is completed, such intermediate data is no longer necessary in a blockchain. Putting such intermediate data in a blockchain results in an event cost based on the type of blockchain consensus. For example, Proof of Work miners charge an event fee for each event in a block. Also, permanent storage of such intermediate data consumes storage space to no end.

Multiple blockchains have block data structures with different event granularities. For example, a first blockchain may add blocks according to a data structure with high event granularity. The first blockchain may store intermediate events until the larger overall event is completed. A second blockchain may add a block digest according to a data structure with low event granularity. The block digest is a digest of the blocks added to the first blockchain. The second blockchain reduces permanent storage, with reduced event cost.

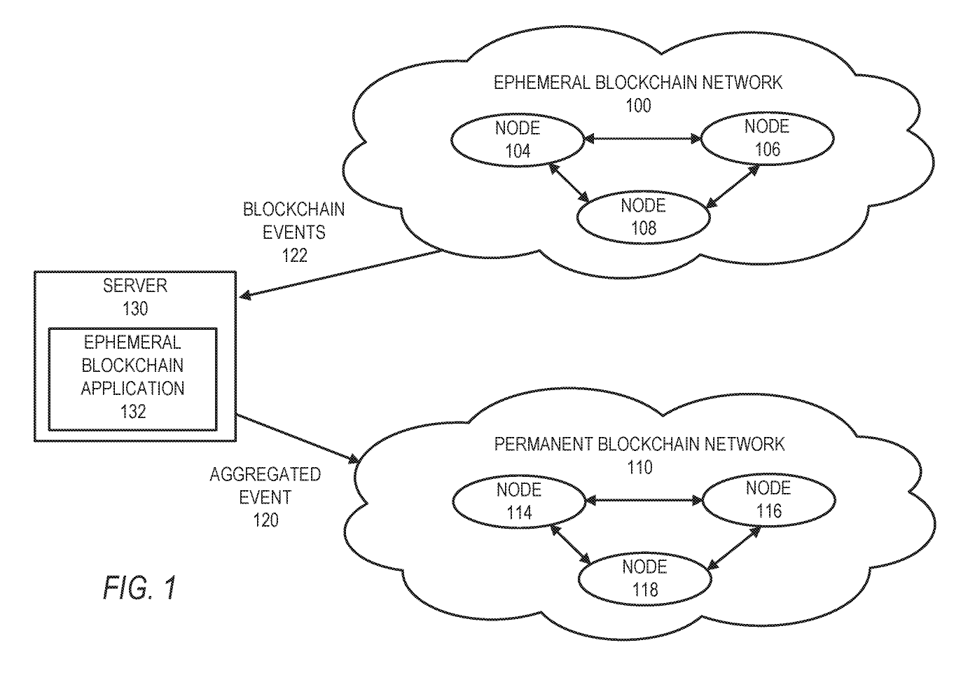

FIG. 1 is a simplified diagram of permanent and ephemeral blockchain networks. An ephemeral blockchain network 100 is shown to have peer-to-peer nodes 104, 106, and 108 that collectively run a consensus protocol to maintain the order of blockchain events stored in the blockchain and purge blockchain events from the blockchain that fail the consensus protocol. A permanent blockchain network 110 has peer-to-peer nodes 114, 116, and 118 that similarly collectively run a consensus protocol.

The ephemeral blockchain network 100 is configured to add multiple blockchain events as new blocks onto the ephemeral blockchain of the ephemeral blockchain network 100. A notice of the new blocks storing multiple blockchain events 122 is sent from the ephemeral blockchain network 100 and received by an ephemeral blockchain application 132 on a server 130. The ephemeral blockchain application 132 generates an aggregated event 120 based on the new blocks storing multiple blockchain events 122, and sends the aggregated event 120 to the permanent blockchain network 110. The permanent blockchain network 110 stores the aggregated event 120 as a new block onto the permanent blockchain of the permanent blockchain network 110. In another embodiment, the aggregated event 120 is stored as multiple new blocks onto the permanent blockchain of the permanent blockchain network 110, so long as the multiple new blocks occupy storage in the permanent blockchain network 110 than the original multiple blockchain events occupied in the ephemeral blockchain network 100. In another embodiment, the aggregated event 120 is stored as multiple new blocks onto the permanent blockchain of the permanent blockchain network 110, so long as the multiple new blocks are fewer than the new blocks storing multiple blockchain events 122 in the ephemeral blockchain network 100. Because the storage requirements are lowered, because fewer event costs are incurred due to fewer new blocks being added to the permanent blockchain, or both, fewer resources are used.

FIG. 1 shows the ephemeral blockchain network 100, permanent blockchain network 110, and server 130 as discrete. However, in some embodiments, there is at least some or even complete overlap. For example, one or more nodes of the ephemeral blockchain network 100 may be shared with one or more nodes of the permanent blockchain network 110. In another example, the ephemeral blockchain application 132 may run on one or more of the nodes of either blockchain network 100, 110.

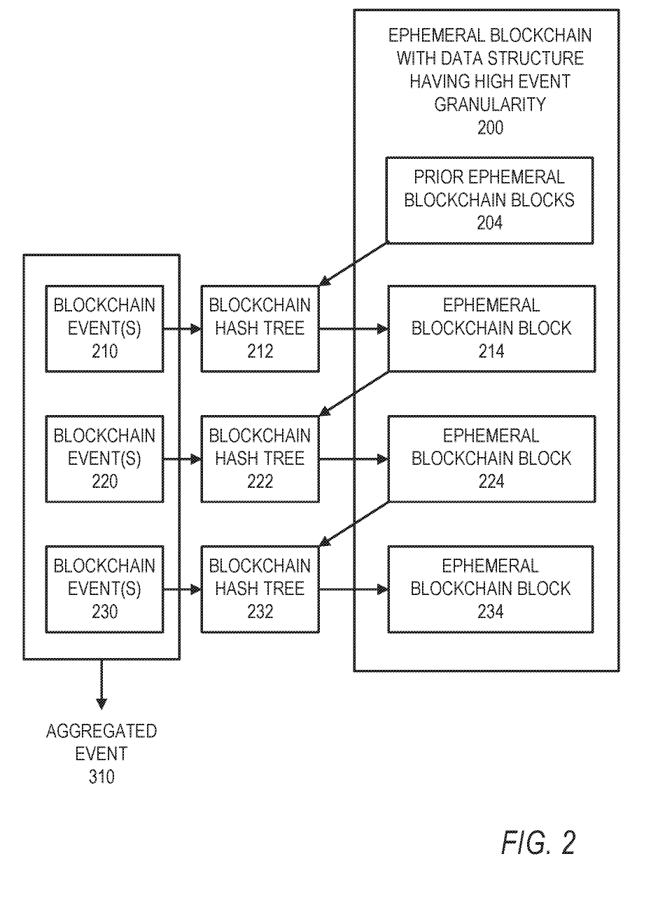

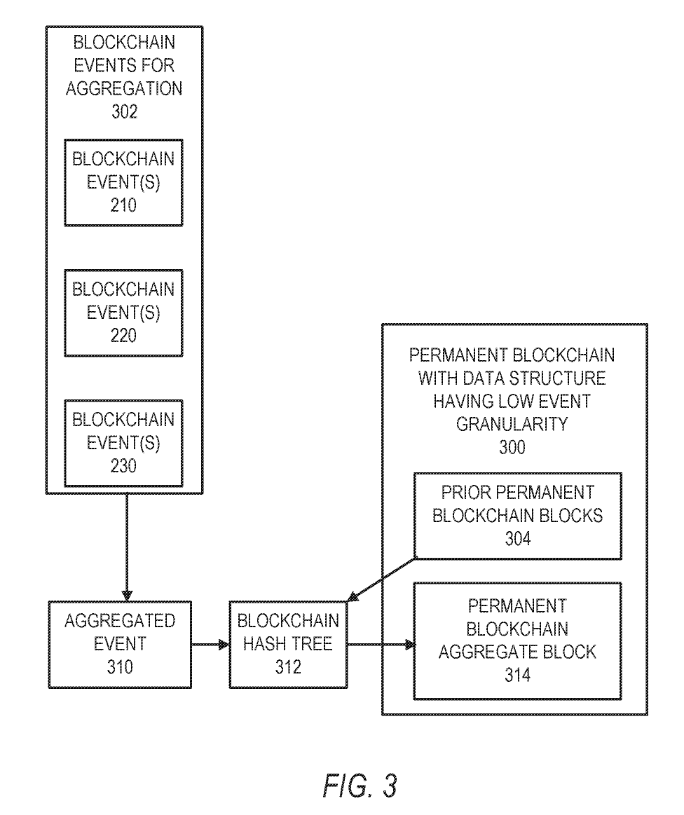

FIG. 2 is a simplified diagram of an ephemeral blockchain 200 growing with additional blocks. The ephemeral blockchain 200 with a data structure having high event granularity has prior ephemeral blockchain blocks 204, and added ephemeral blockchain blocks 214, 224, and 234. The added ephemeral blockchain blocks 214, 224, and 234 respectively store new blockchain event(s) 210, 220, and 230. The ephemeral blockchain block 214 is based on a blockchain hash tree 212 incorporating the blockchain event(s) 210 and at least part of a preceding block of the prior ephemeral blockchain blocks 204. The ephemeral blockchain block 224 is based on a blockchain hash tree 222 incorporating the blockchain event(s) 220 and at least part of the preceding ephemeral blockchain block 214. The ephemeral blockchain block 234 is based on a blockchain hash tree 232 incorporating the blockchain event(s) 230 and at least part of the preceding ephemeral blockchain block 224. Blockchain events for aggregation 302 includes new blockchain event(s) 210, 220, and 230 are the basis of an aggregated event 310, used in FIG. 3.

FIG. 3 is a simplified diagram of a permanent blockchain 300 growing with an additional block in the form of a digest block. The permanent blockchain 300 with a data structure having low event granularity has prior permanent blockchain blocks 304 and an added permanent blockchain aggregate block 314. The added permanent blockchain aggregate block 314 stores the aggregated event 310. In one embodiment, the aggregated event 310 includes a compilation of the blockchain event(s) 210, 220, and 230, such as parties involved in the blockchain event(s) 210, 220, and 230 along with the respective blockchain event(s) 210, 220, and 230. In one embodiment, the aggregated event 310 includes a summary of the blockchain event(s) 210, 220, and 230, such as the overall event that represents the culmination of the blockchain event(s) 210, 220, and 230. The permanent blockchain aggregate block 314 is based on a blockchain hash tree 312 incorporating the aggregated event 310 and at least part of a preceding block of the prior permanent blockchain blocks 304.

The data structure of the permanent blockchain 300 has low event granularity and the data structure of the ephemeral blockchain 200 has high event granularity in that an added permanent blockchain 300 block represents more underlying blockchain events than does an added ephemeral blockchain 200 block.

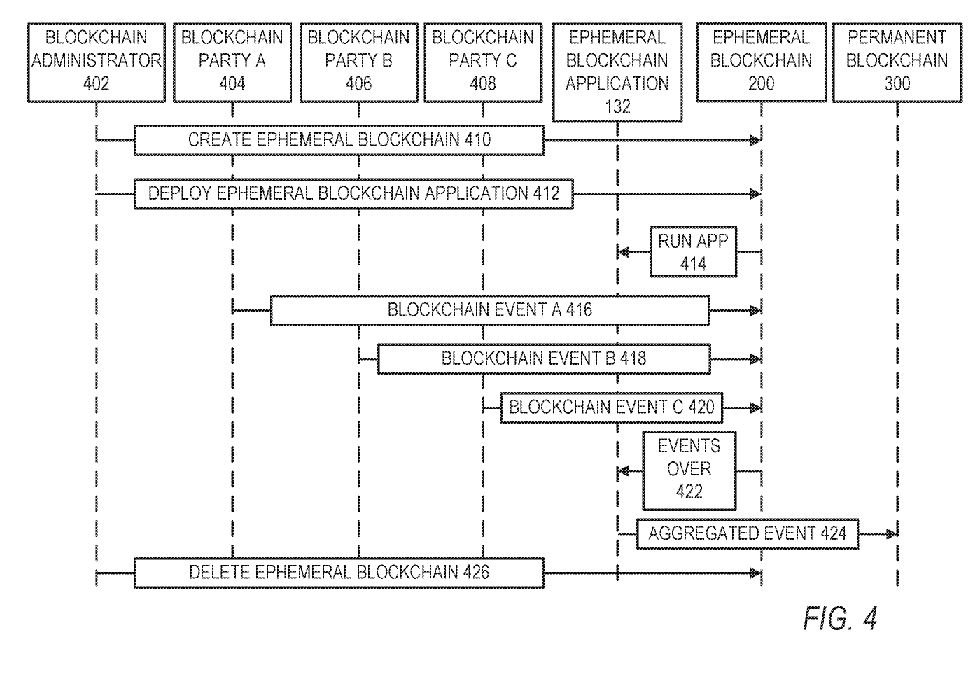

FIG. 4 is an example use case diagram showing the interaction among entities with a regularly deleted ephemeral blockchain. The ephemeral blockchain addresses the problem of intermediate data. On the one hand, intermediate data is of no further use after an overall event is complete. On the other hand, in some cases the intermediate data assists in a tamper-proof guarantee, for example in a process that could span hours or days. In one use case, a multi-party work order involves airplane maintenance or locomotive maintenance. Here the work order goes through multiple steps, with different steps being completed by different parties that may not know or trust each other. After all the steps are complete, the final signoff occurs. If all these steps are recorded on the blockchain, the result is one event recorded per step, with one additional event for signoff. While it is important to maintain the events that record intermediate steps while the work order is in progress, the record of such intermediate steps is of little significance after the work order is complete as long as the signoff transaction is permanently recorded along with a record of which party completed which step. The end result of the overall event is an example of the bare minimum of what to store permanently in the permanent blockchain.

FIG. 4 shows a blockchain administrator 402, blockchain party A 404, blockchain party B 406, blockchain party C 408, the ephemeral blockchain application 132, the ephemeral blockchain 200, and the permanent blockchain 300. The blockchain administrator 402 sends an instruction to create an ephemeral blockchain 410, specifying options such as the consensus algorithm, number of nodes, and lifetime of the ephemeral blockchain 200. The blockchain administrator 402 sends an instruction to deploy the ephemeral blockchain application 412. In response, the ephemeral blockchain 200 sends an instruction to run the ephemeral blockchain application 414. Blockchain party A 404, blockchain party B 406, and blockchain party C 408 respectively send blockchain event A 416, blockchain event B 418, and blockchain event C 420 to the ephemeral blockchain 200, resulting in the addition of respective new ephemeral blocks to the ephemeral blockchain 200. After completion of the overall blockchain event encompassing blockchain event A 416, blockchain event B 418, and blockchain event C 420, the ephemeral blockchain 200 notifies the ephemeral blockchain application 132 that the new blockchain events are over 422. The ephemeral blockchain application 132 generates and sends an aggregated event 424 based on blockchain event A 416, blockchain event B 418, and blockchain event C 420 to the permanent blockchain 300, resulting in the addition of a new permanent blockchain block to the permanent blockchain 300. The blockchain administrator 402 sends an instruction to delete the ephemeral blockchain 426 to the ephemeral blockchain 200.

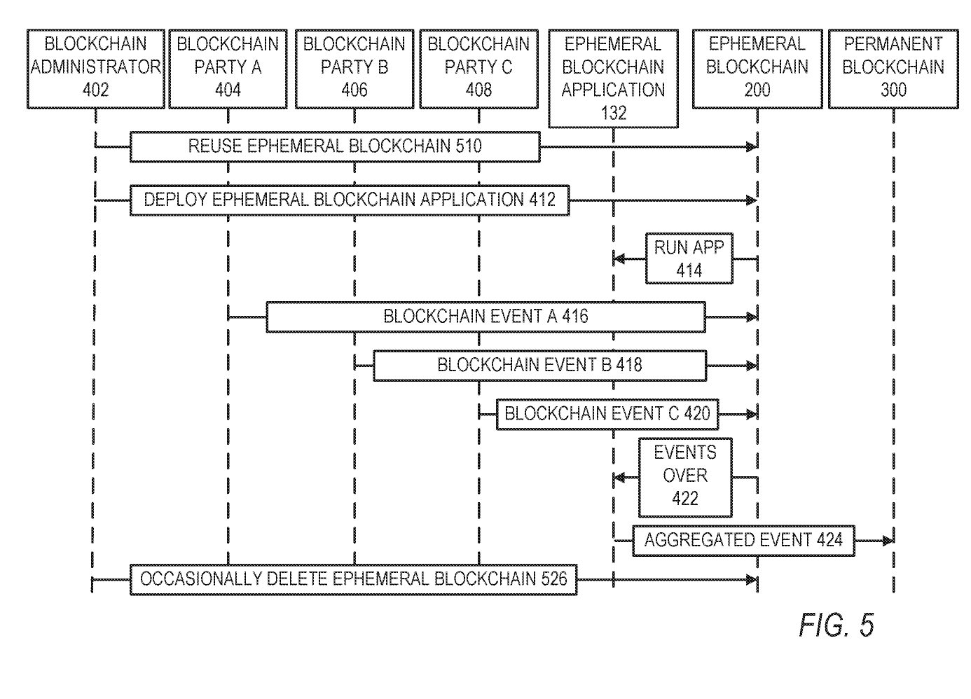

FIG. 5 is an example use case diagram showing the interaction among entities with an occasionally deleted ephemeral blockchain. FIG. 5 is similar to FIG. 4. However, FIG. 5 shows an alternative to creating a new ephemeral blockchain. The blockchain administrator 402 sends an instruction to reuse an ephemeral blockchain 510. Afterwards, the ephemeral blockchain 200 may or may not be deleted. The blockchain administrator 402 occasionally sends an instruction to delete the ephemeral blockchain 526. In response to the blockchain administrator 402 not sending the instruction to delete the ephemeral blockchain 526, on a subsequent occasion to use an ephemeral blockchain, the ephemeral blockchain 200 is reused as in FIG. 5. In response to the blockchain administrator 402 sending the instruction to delete the ephemeral blockchain 526, on a subsequent occasion to use an ephemeral blockchain, a new ephemeral blockchain 200 is created as in FIG. 4.

### Example Software Architecture

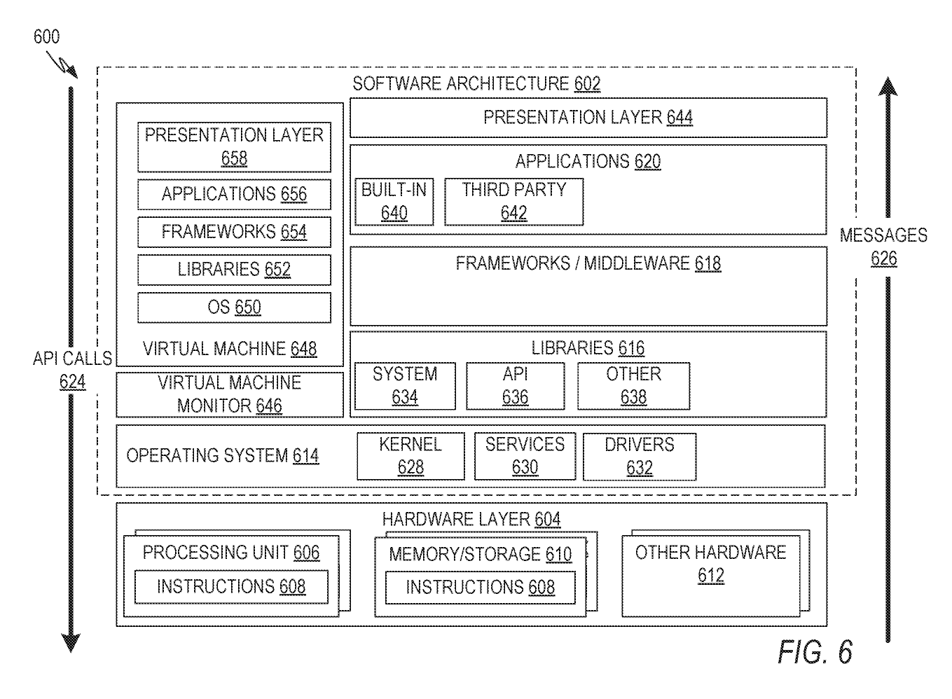

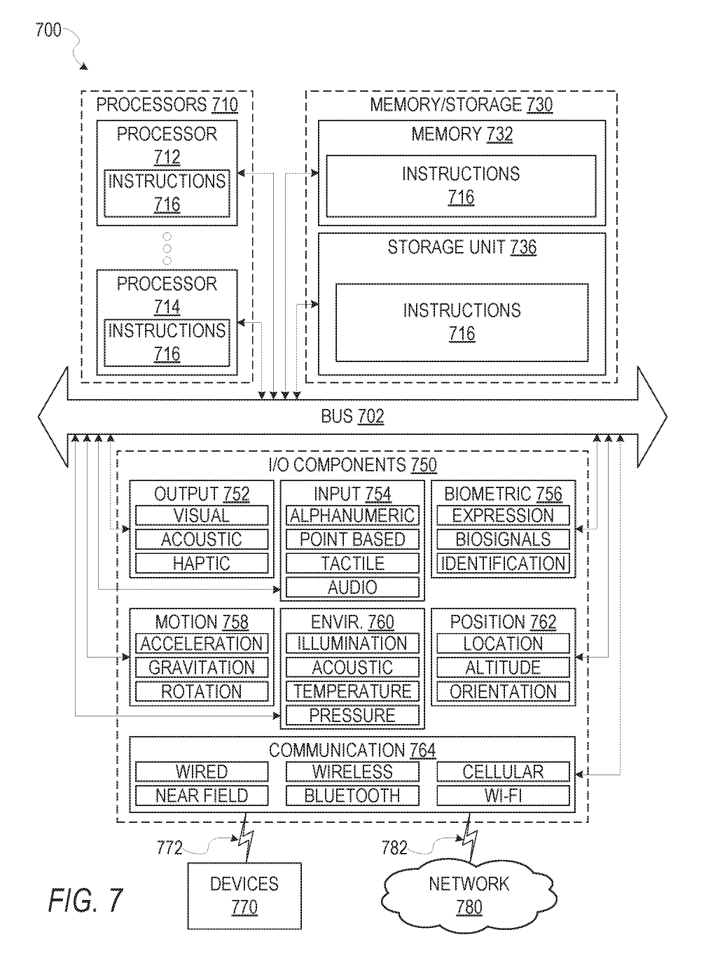

FIG. 6 is a block diagram 600 illustrating a representative software architecture 602, which may be used in conjunction with various hardware architectures herein described. FIG. 6 is merely a non-limiting example of a software architecture 602, and it will be appreciated that many other architectures may be implemented to facilitate the functionality described herein. The software architecture 602 may be executing on hardware such as a machine 700 of FIG. 7 that includes, among other things, processors 710, memory/storage 730, and I/O components 750. A representative hardware layer 604 is illustrated in FIG. 6 and can represent, for example, the machine 700 of FIG. 7. The representative hardware layer 604 comprises one or more processing units 606 having associated executable instructions 608. The executable instructions 608 represent the executable instructions of the software architecture 602, including implementation of the methods, modules, and so forth of FIGS. 1-5. The hardware layer 604 also includes memory and/or storage modules 610, which also have the executable instructions 608. The hardware layer 604 may also comprise other hardware 612, which represents any other hardware of the hardware layer 604, such as the other hardware illustrated as part of the machine 700.

In the example architecture of FIG. 6, the software architecture 602 may be conceptualized as a stack of layers where each layer provides particular functionality. For example, the software architecture 602 may include layers such as an operating system 614, libraries 616, frameworks/middleware 618, applications 620, and a presentation layer 644. Operationally, the applications 620 and/or other components within the layers may invoke application programming interface (APT) calls 624 through the software stack and receive a response, returned values, and so forth, illustrated as messages 626, in response to the API calls 624. The layers illustrated are representative in nature, and not all software architectures have all layers. For example, some mobile or special-purpose operating systems may not provide a frameworks/middleware 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide a common infrastructure that may be utilized by the applications 620 or other components or layers. The libraries 616 typically provide functionality that allows other software modules to perform tasks in an easier fashion than by interfacing directly with the underlying operating system 614 functionality (e.g., kernel 628, services 630, and/or drivers 632). The libraries 616 may include system libraries 634 (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks/middleware 618 may provide a higher-level common infrastructure that may be utilized by the applications 620 or other software components/modules. For example, the frameworks/middleware 618 may provide various graphic user interface (GUI) functions, high-level resource management, high-level location services, and so forth. The frameworks/middleware 618 may provide a broad spectrum of other APIs that may be utilized by the applications 620 or other software components/modules, some of which may be specific to a particular operating system or platform.

The applications 620 include built-in applications 640 or third-party applications 642. Examples of representative built-in applications 640 may include, but are not limited to, a contacts application, a browser application, a book reader application, a location application, a media application, a messaging application, or a game application. The third-party applications 642 may include any of the built-in applications 640 as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 642 may invoke the API calls 624 provided by the mobile operating system such as the operating system 614 to facilitate functionality described herein.

The applications 620 may utilize built-in operating system functions (e.g., kernel 628, services 630, and/or drivers 632), libraries (e.g., system libraries 634, API libraries 636, and other libraries 638), and frameworks/middleware 618 to create user interfaces to interact with users of the system. Alternatively, or additionally, in some systems, interactions with a user may occur through a presentation layer, such as the presentation layer 644. In these systems, the application/module “logic” can be separated from the aspects of the application/module that interact with a user.

Some software architectures utilize virtual machines. In the example of FIG. 6, this is illustrated by a virtual machine 648. A virtual machine creates a software environment where applications/modules can execute as if they were executing on a hardware machine (e.g., the machine 700 of FIG. 7). A virtual machine is hosted by a host operating system (e.g., operating system 614) and typically, although not always, has a virtual machine monitor 646, which manages the operation of the virtual machine 648 as well as the interface with the host operating system (e.g., operating system 614). A software architecture executes within the virtual machine 648, such as an operating system 650, libraries 652, frameworks 654, applications 656, or a presentation layer 658. These layers of software architecture executing within the virtual machine 648 can be the same as corresponding layers previously described or may be different.

### Example Machine Architecture and Machine-Readable Medium

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may cause the machine 700 to execute the processes of FIGS. 1-6. The instructions 716 transform the general, non-programmed machine 700 into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 71.6 to perform any one or more of the methodologies discussed herein.

The machine 700 may include processors 710, memory/storage 730, and 110 components 750, which may be configured to communicate with each other such as via a bus 702. In an example embodiment, the processors 710 (e.g., a. Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 712 and a processor 714 that may execute the instructions 716. The term “processor” is intended to include a multi-core processor that may comprise two or more independent processors (sometimes referred to as “cores”) that may execute the instructions 716 contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and the memory 732 store the instructions 716 embodying any one or more of the methodologies or functions described herein. The instructions 716 may also reside, completely or partially, within the memory 732, within the storage unit 736, within at least one of the processors 710 within the processor's cache memory), or any suitable combination thereof, during execution thereof by the machine 700. Accordingly, the memory 732, the storage unit 736, and the memory of the processors 710 are examples of machine-readable media.

As used herein, “machine-readable medium” means a device able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine (e.g., processors 710), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772 respectively. For example, the communication components 764 may include a network interface component or other suitable device to interface with the network 780. In further examples, the communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geo-location, location via Wi-Fi® signal triangulation, location via detecting an NEC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A method comprising:
causing one or more networking devices to transmit instructions that when executed by one or more processors, cause the one or more processors to perform operations comprising:
processing a plurality of blockchains with a plurality of block data structures, the plurality of block data structures including a first block data structure and a second block data structure, the plurality of block data structures having a plurality of event granularities, the plurality of event granularities having a first event granularity and a second event granularity, the first event granularity having more event granularity than the second event granularity, the operations including:
processing a first blockchain of the plurality of blockchains to add a plurality of blockchain blocks according to the first block data structure, the first block data structure having the first event granularity, each subsequent blockchain block of the plurality of blockchain blocks corresponding to a first lengthened recalculated hash of the first blockchain; and
processing a second blockchain of the plurality of blockchains to add a blockchain block digest according to the second block data structure, the second block data structure having the second event granularity, the blockchain block digest being a digest of the plurality of blockchain blocks, and the blockchain block digest corresponding to a second lengthened recalculated hash of the second blockchain.

2. The method of claim 1, further comprising:
responsive to the processing the second blockchain of the plurality of blockchains to add the blockchain block digest, allowing deletion of the plurality of blockchain blocks of the first blockchain.

3. The method of claim 1, further comprising:
responsive to the processing the second blockchain of the plurality of blockchains to add the blockchain block digest, allowing reuse of the first blockchain for a second plurality of blockchain blocks.

4. The method of claim 1, wherein the blockchain block digest is shorter than the plurality of blockchain blocks.

5. The method of claim 1, wherein the blockchain block digest corresponds to a. lower number of blockchain blocks than the plurality of blockchain blocks.

6. The method of claim 1, wherein the blockchain block digest of the second blockchain represents a subset of the plurality of blockchain blocks of the first blockchain.

7. The method of claim 6, wherein the blockchain block digest of the second blockchain omits one or more of the plurality of blockchain blocks prior to a final one of the plurality of blockchain blocks.

8. A non-transitory computer-readable medium embodying instructions that, when executed by one or more processors, cause the one or more processors to perform operations comprising:
processing, using the one or more processors of one or more computing devices, a plurality of blockchains with a plurality of block data structures, the plurality of block data structures including a first block data structure and a second block data structure, the plurality of block data structures having a plurality of event granularities, the plurality of event granularities having a first event granularity and a second event granularity, the first event granularity having more event granularity than the second event granularity, the operations including:
processing a first blockchain of the plurality of blockchains to add a plurality of blockchain blocks according to the first block data structure, the first block data structure having the first event granularity, each subsequent blockchain block of the plurality of blockchain blocks corresponding to a first lengthened recalculated hash of the first blockchain; and
processing a second blockchain of the plurality of blockchains to add a blockchain block digest according to the second block data structure, the second block data structure having the second event granularity, the blockchain block digest being a digest of the plurality of blockchain blocks, and the blockchain block digest corresponding to a second lengthened recalculated hash of the second blockchain.

9. The non-transitory computer-readable medium of claim 8, the operations further comprising:
responsive to the processing the second blockchain of the plurality of blockchains to add the blockchain block digest, allowing deletion of the plurality of blockchain blocks of the first blockchain.

10. The non-transitory computer-readable medium of claim 8, the operations further comprising:
responsive to the processing the second blockchain of the plurality of blockchains to add the blockchain block digest, allowing reuse of the first blockchain for a second plurality of blockchain blocks.

11. The non-transitory computer-readable medium of claim 8, wherein the blockchain block digest is shorter than the plurality of blockchain blocks.

12. The non-transitory computer-readable medium of claim 8, wherein the blockchain block digest corresponds to a lower number of blockchain blocks than the plurality of blockchain blocks.

13. The non-transitory computer-readable medium of claim 8, wherein the blockchain block digest of the second blockchain represents a subset of the plurality of blockchain blocks of the first blockchain.

14. The non-transitory computer-readable medium of claim 13, wherein the blockchain block digest of the second blockchain omits one or more of the plurality of blockchain blocks prior to a final one of the plurality of blockchain blocks.

15. A computing system comprising
a memory;
one or more hardware processors coupled to the memory; and
one or more processor-implemented blockchain modules configured to perform, on the one or more hardware processors, operations comprising:
processing, using the one or more hardware processors, a plurality of blockchains with a plurality of block data structures, the plurality of block data structures including a first block data structure and a second block data structure, the plurality of block data structures having a plurality of event granularities, the plurality of event granularities having a first event granularity and a second event granularity, the first event granularity having more event granularity than the second event granularity, the operations including:
processing a first blockchain of the plurality of blockchains to add a plurality of blockchain blocks according to the first block data structure, the first block data structure having the first event granularity, each subsequent blockchain block of the plurality of blockchain blocks corresponding to a first lengthened recalculated hash of the first blockchain; and
processing a second blockchain of the plurality of blockchains to add a blockchain block digest according to the second block data structure, the second block data structure having the second event granularity, the blockchain block digest being a digest of the plurality of blockchain blocks, and the blockchain block digest corresponding to a second lengthened recalculated hash of the second blockchain.

16. The computing system of claim 15, the operations further comprising:
responsive to the processing the second blockchain of the plurality of blockchains to add the blockchain block digest, allowing deletion of the plurality of blockchain blocks of the first blockchain.

17. The computing system of claim 15, the operations further comprising:
responsive to the processing the second blockchain of the plurality of blockchains to add the blockchain block digest, allowing reuse of the first blockchain for a second plurality of blockchain blocks.

18. The computing system of claim 15, wherein the blockchain block digest is shorter than the plurality of blockchain blocks.

19. The computing system of claim 15, wherein the blockchain block digest corresponds to a lower number of blockchain blocks than the plurality of blockchain blocks.

20. The computing system of claim 15, wherein the blockchain block digest of the second blockchain represents a subset of the plurality of blockchain blocks of the first blockchain.
